(19) United States
(12) Patent Application Publication
(10) Pub. No.: US 2003/0117494 A1
(43) Pub. Date: Jun. 26, 2003

(54) Airplane cbb/security camera system interface

(76) Inventor: Daniel Dante Poblete, Lake Forest, CA (US)

Correspondence Address: Mark D. Elchuk, Harness, Dickey & Pierce P.L.C., P.O. Box 828, Bloomfield Hills, MI, 48303, US

(21) Appl. No.: 10/032,345

(22) Filed: Dec. 21, 2001

(51) Int. Cl. H04N 7/18

(52) U.S. Cl. 348/148; 348/143

(57) ABSTRACT

An airborne surveillance system for monitoring activity on an aircraft flight deck and in a passenger compartment of an aircraft or other form of mobile platform and relaying the images in real time to a remote monitoring location. The surveillance system also allows a party at the remote monitoring location to send signals to control movement of cameras located on the mobile platform and provides for the storage of the camera images by a recorder apparatus of the system, as well as at the remote monitoring location.

### FIELD OF THE INVENTION

The present invention relates to aircraft security systems. More specifically, the present invention relates to a surveillance system capable of monitoring aircraft passengers and crew members.

### BACKGROUND OF THE INVENTION

In order to monitor and record the events onboard an aircraft, aircraft are increasingly being outfitted with surveillance systems. Aircraft surveillance systems have traditionally been confined to flight deck audio recorders. However, due to the increasing number of onboard disturbances and flight deck intrusions, a need has arisen to develop enhanced electronic video surveillance systems which monitor not only the flight deck but also the passenger cabin.

Currently, there are several video surveillance devices which may be used to adequately record the events occurring on an aircraft flight deck or within an aircraft passenger compartment. However, such devices simply store the recorded events using an electronic storage device for later retrieval. Present day surveillance devices do not have the capability of transmitting the onboard events in real-time to outside authorities, thus depriving the authorities of the opportunity to provide a response in an attempt to rectify any technical difficulties or thwart any unlawful events which may be taking place onboard. Further, the information stored by such devices is subject to being destroyed as the result of an aircraft crash or due to intentional destruction by an onboard person acting in an unlawful manner.

Consequently, there is a need for an aircraft surveillance system that is able to monitor the events of an aircraft flight deck and passenger compartment and relay real time images of the events to a remote party, to allow the remote party to control movement of the cameras, and to permit the storage of the camera images by the remote party. Advantageously, the surveillance system would be comprised of a plurality of video cameras which may not only be individually rotated but also outfitted with a zoom lens feature allowing a particular point of interest to be viewed in detail. The cameras may be of numerous shapes and sizes but the customer should have the option of purchasing cameras which are of a size which would permit concealment of the cameras within a ceiling panel or interior bulkhead. Further, the cameras should preferably be light in weight so as to not add to the operating costs of the aircraft and be low light, high resolution, color cameras that will produce an image that meets or exceeds the image quality standards set by the National Television Standards Committee.

### SUMMARY OF THE INVENTION

The present invention overcomes the deficiencies of the prior art by providing an aircraft surveillance system that is able to monitor the events of an aircraft flight deck and passenger compartment and relay the images in real time to a remote party. The surveillance system also allows the remote party to control movement of the cameras and provides for the storage of the camera images by the remote party. The surveillance system is comprised of a plurality of video cameras which may not only be individually rotated, but may also be outfitted with a zoom feature allowing a particular area of interest to be viewed in detail. Cameras of various shapes and sizes may be used, but cameras which are of a size so as to permit concealment of the cameras within a ceiling panel or interior bulkhead are preferred. The preferred cameras are also low light, high resolution, color cameras that are light in weight and produce an image that is of National Television Standards Committee quality.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a simplified block diagram of a preferred embodiment of the surveillance system of the present invention, the diagram illustrating the transfer of video images in the form of electronic signals from a security camera to a remote user and the control of the cameras by the remote user;

FIG. 2 is a schematic illustration of an aircraft fuselage outfitted with the surveillance system of the present invention;

FIG. 3 is a an enlarged view of the aircraft flight deck of FIG. 2;

FIG. 4 is an enlarged view of an aircraft bulkhead of FIG. 2 illustrating a video camera of the surveillance system in a concealed position; and

FIG. 5 is an enlarged view of two of the aircraft bulkheads of FIG. 2 illustrating video cameras of the surveillance system in exposed positions.

### DETAILED DESCRIPTION OF THE PREFERRED EMBODIMENTS

The following description of the preferred embodiment(s) is merely exemplary in nature and is in no way intended to limit the invention, its application, or uses.

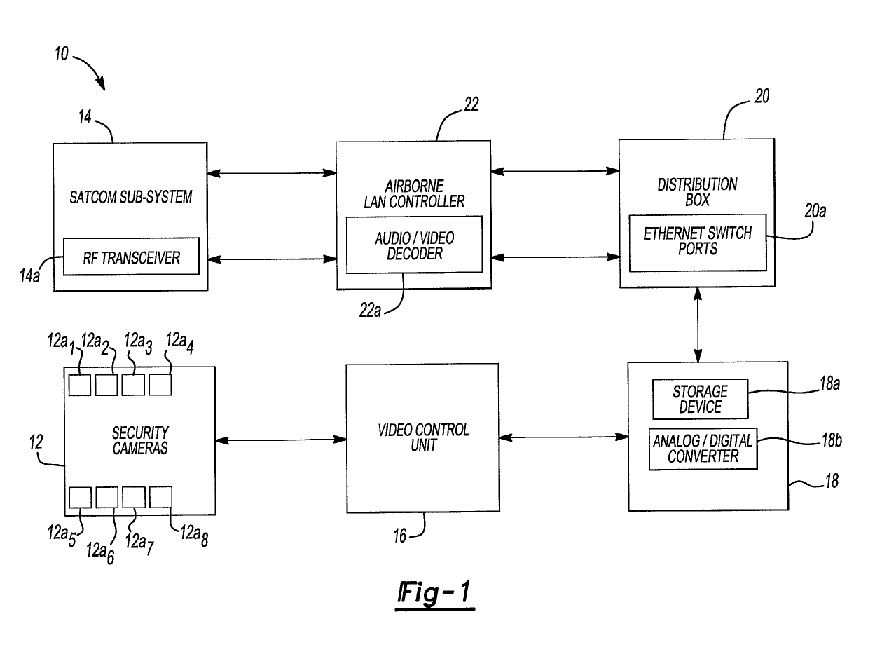

With initial reference to FIG. 1, a system 10 adapted for use with a mobile platform is shown. The system 10 allows for the transfer of data from a security camera system 12 to a remote party through the use of a satellite communications (SATCOM) system. The SATCOM system consists of a SATCOM subsystem 14 which communicates radio frequency signals to satellite based transponders, the transponders further communicating the radio frequency signals to ground based radio frequency receivers/transmitters. While the system 10 as illustrated focuses on the use of a video monitoring device, the invention may also be outfitted to include an audio monitoring device as well.

The camera system 12 includes a plurality of independent cameras 12a₁-12a₈. The cameras 12a produce electronic signals representing the video images captured by the camera system 12. In practice, it is anticipated that the use of a plurality of cameras 12a will be most preferred, particularly within mobile platforms such as commercial aircraft so as to allow an entire cabin area and/or flight deck to be viewed substantially simultaneously. The camera system 12 is also in receipt of electronic signals from the remote party, the signals representing camera operating commands. The commands will vary depending on the capabilities of the cameras 12a, but may include instructions for the cameras 12a to rotate, pan, or zoom so as to allow the user to view a particular area of interest.

The type and quality of the cameras 12a used may vary according to user preference. However, the cameras 12a are preferably low light, high resolution, color cameras that produce images that meet or exceed the standards set by the National Television Standards Committee (NTSC). Optionally, the cameras 12a may be infrared cameras that are able to record images when little or no light is present to illuminate the viewing area. The cameras 12a may optionally be rotatable cameras equipped with a zoom feature and may be of a small size, such as a pinhole camera, so that they may be concealed within a ceiling panel or interior bulkhead. A variety of suitable surveillance cameras are produced in the marketplace. Two examples of suitable cameras are the CMF-01 and the CMC-01 manufactured by Securaplane Technologies. The CMC-01 is particularly well suited to covert monitoring as it is a pinhole camera.

The system 10 further includes a video control unit 16. The video control unit 16 supplies the electricity to operate the cameras 12a. The video control unit 16 also serves as a junction box connecting the feeds of the multiple cameras 12a. The video control unit 16 is also used to connect the feeds of the cameras 12a to an onboard computer server 18. Further, the video control unit 16 acts as a surge protector in that it cuts off power to the cameras 12a when a sudden spike in electrical current is experienced.

Electronic signals are transmitted between the video control unit 16 and the security cameras 12a through a suitable cable assembly such as one or more coaxial cables. The transmission is a two-way transmission as the cameras 12a are capable of transmitting the video data collected while also being capable of receiving commands from a remote user. The electric current used to power the cameras 12a is transmitted to the cameras 12a using a suitable cable assembly such as a 28v twisted pair wire.

The system 10 further comprises a server 18. The server 18 is comprised of a storage device 18a and an analog/digital converter 18b. The security camera video transmissions are in the form of analog signals. Thus, for the signals to be electronically stored and transmitted through the satellite communications (SATCOM) subsystem 14 they must be converted to digital signals using the analog/digital converter 18b. Likewise, when digital commands are transmitted to the cameras 12a through the SATCOM subsystem 14 they must be converted to analog signals in order to be transmitted to the cameras 12a. The video transmissions are stored on the server 18 using storage device 18a, which may comprise a computer hard disk drive or a tape drive. The signals from the security cameras 12a are transmitted to the server 18 by way of a suitable cable assembly such as a coaxial cable. In a similar fashion, the control signals from the remote user are transmitted to the camera system 12 by one or more suitable cables such as coaxial cables.

The system 10 further includes a distribution box 20. The distribution box 20 contains an Ethernet switch 20a which may be equipped with any number of ports, but in one preferred embodiment with eleven ports. The switch 20a provides an interface between the surveillance cameras 12a and a local area network (LAN) 22 of the SATCOM subsystem 14. The digital video signal stored on the server 18 is transferred from the server 18 to one of the ports of the Ethernet switch 20a by way of a suitable cable assembly such as an RJ45 cable assembly. Likewise, camera commands given by the remote user are transferred from the distribution box 20 to the server 18 using a suitable cable assembly such as an RJ45 cable assembly.

The system 10 further comprises an airborne LAN 22. The airborne LAN 22 distributes signals received by the aircraft's SATCOM subsystem 14 and receives signals from the airborne distribution box 20 to be transmitted by the SATCOM subsystem 14. The digital video signals fed through the distribution box 20 are transmitted to the airborne LAN 22 using a suitable cable assembly and are transferred at preferably either 100 or 10 megabytes per second. Likewise, the camera control signals sent from the remote user which are transferred through the airborne LAN 22 are transferred to the distribution box 20 through a suitable cable assembly and are transferred at preferably either 100 or 10 megabytes per second.

Airborne LAN 22 also contains an audio/video decoder 22a. The decoder 22a is used to convert the digital video signals emitted from the video cameras 12a to a format suitable for transmission by the SATCOM subsystem 14. In a similar manner, the audio/video decoder 22a decodes camera control signals sent by the remote user so as to put the signals in a suitable format to be transferred through the airborne LAN 22 and subsequently to the security cameras 12a themselves. It will be appreciated that if no audio monitoring of the interior of the aircraft is desired, then the audio decoding capability is not needed.

The SATCOM subsystem 14 includes an onboard RF transceiver 14a which sends and receives signals from the airborne LAN 22 at a rate of preferably either 100 or 10 megabytes per second using a suitable cable assembly. The RF transceiver 14a communicates signals to an orbiting satellite and the satellite communicates signals to a remotely located SATCOM station, such as for example a SATCOM ground station. The remotely located SATCOM station then communicates the signals to a suitable network operations center where signals may be received and transmitted by a user in communication with the network operations center through a suitable communications medium such as the Internet. The images may be stored by either the remotely located SATCOM station, the network operations center, or another remote user using a suitable electronic storage device.

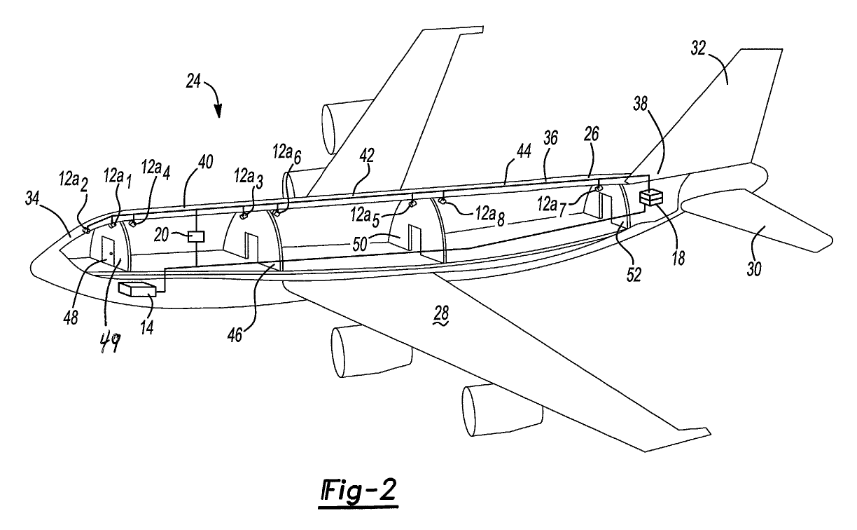

FIG. 2 shows the aircraft security system 10 described above installed in an aircraft generally illustrated at 24. It will be appreciated, however, that the system 10 is equally well adopted for use on a variety of other forms of mobile platforms such as land vehicles and ships. The aircraft 24 is comprised of a fuselage 26, a pair of wings 28, a pair of horizontal stabilizers 30, and a vertical stabilizer 32. The fuselage 26 contains a flight deck 34, a passenger cabin compartment 36, and a tail section 38. The passenger cabin compartment 36 may be divided into several sub-compartments such as a first class cabin 40, a business class cabin 42, and an economy class cabin 44.

The aircraft 24 may be outfitted with one or a plurality of the security cameras 12a positioned in a wide variety of placements. The number and placement of the security cameras 12a will depend on particular user preference and need. However, in one preferred embodiment of the invention, the aircraft 24 has two cameras 12a in the flight deck 34, two cameras 12a in the first class cabin 40, two cameras 12a in the business class cabin 42, and two cameras 12a in the economy class cabin 44. This arrangement of cameras 12a allows for coverage of virtually the entire flight deck 34 and the entire passenger cabin 36 within the aircraft 24.

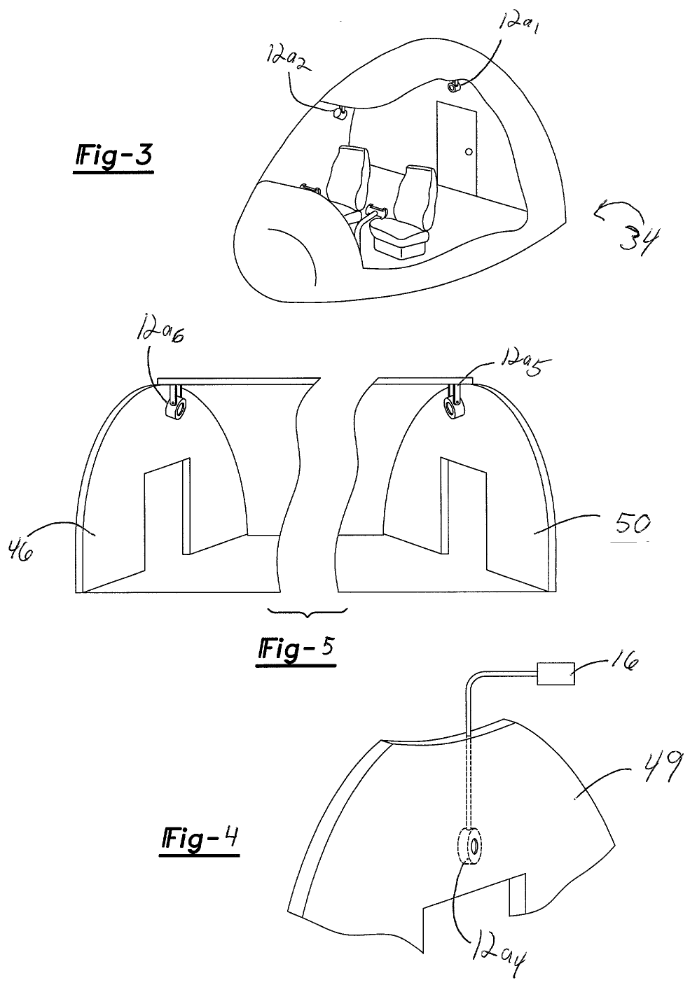

In the preferred embodiment of Applicant's invention the flight deck 34 has a forward facing camera 12a₁ and an aft facing camera 12a₂ as illustrated in FIG. 3. The forward facing camera 12a₁ provides video monitoring of the pilots and the aircraft displays. The camera 12a₁ may be mounted in either a ceiling of the flight deck 34 or in a wall of the flight deck 34. Further, the camera 12a₁ may be mounted in either a concealed or exposed manner. The aft facing camera 12a₂ will provide video monitoring of the pilots and other crew members in the flight deck 34. The camera 12a₂ may be mounted in the ceiling of the flight deck 34 or in a wall of the flight deck 34. The camera 12a₂ may also be mounted in either a concealed or exposed manner.

The first class cabin 40 will have an aft mounted camera 12a₃. Aft mounted camera 12a₃ is preferably mounted to a bulkhead 46 or in the aft ceiling of cabin 42. The camera 12a₃ may be mounted in either an exposed or concealed manner. The aft mounted camera 12a₃ faces the front of the aircraft 24 so as to monitor the security of a flight deck entrance door 48. The first class cabin 40 also has a forward mounted camera 12a₄. FIG. 4 illustrates forward mounted camera 12a₄ mounted to a bulkhead 49 in a concealed manner. However, camera 12a may also be mounted to bulkhead 49 in an exposed manner as well as mounted to the ceiling of cabin 40 in a concealed or exposed manner. Regardless of the placement of the camera 12a₄ or the manner in which it is secured, the camera 12a₄ is preferably positioned so as to monitor a person approaching the flight deck door 48.

The business class cabin 42 has an aft mounted camera 12a₅. FIG. 5 illustrates aft mounted camera 12a₅ mounted to an aft ceiling of cabin 42 in an exposed manner. However, camera 12a₅ may also be concealed within the aft ceiling of cabin 42, as well as mounted to a bulkhead 50 in either a concealed or exposed manner. The aft mounted camera 12a₅ is positioned to monitor the activity of the business class cabin 42 from an aft view. The business class cabin 42 also has a forward mounted camera 12a₆. FIG. 5 illustrates the camera 12a₆ mounted to a forward ceiling of cabin 42 in an exposed manner. However, camera 12a₆ may also be concealed within the forward ceiling, as well as mounted to bulkhead 46 in either a concealed or exposed manner. The camera 12a₆ is positioned so as to monitor the activity of the business class cabin 44 from a forward view.

The economy class cabin 44 has an aft mounted camera 12a₇. The aft mounted camera 12a₇ is preferably mounted to a bulkhead 52 or to the aft ceiling of the cabin 44. The aft mounted camera 12a₇, like the cameras 12a described previously, may be mounted in either an exposed or concealed position. The aft mounted camera 12a₇ is positioned to monitor the activity of the economy class cabin 44 from an aft view. The economy class cabin 44 has a forward mounted camera 12a₈. The camera 12a₈ is mounted at a forward end of cabin 44, such as in bulkhead 50 or the forward ceiling of the cabin 44, and is positioned so as to monitor the activity of the economy class cabin 44 from a forward view. The camera 12a₈ may be mounted in a concealed or exposed position.

The above described security cameras 12a are interconnected using a plurality of suitable cable assemblies such as coaxial cable assemblies. The cameras 12a are connected to the video control unit (VCU) 16 as described herein.

Thus, an airborne video surveillance system 10 is provided. The surveillance system 10 allows the images obtained by onboard video cameras to be transmitted by way of a satellite communications network to a remote user so that the user may view the camera images in real time. Further, the surveillance system 10 allows the remote user to actively control the zoom and directional orientation of the cameras so that the viewer can focus his/her attention on a particular area. Consequently, the events onboard the aircraft may be actively monitored so as to provide remote authorities with the opportunity to prepare an appropriate response to an emergency situation.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A surveillance system adapted for use on a mobile platform and adapted for communicating real time video of a desired portion of said mobile platform to a remotely located monitoring station, comprising:
at least one video camera positioned on said mobile platform to view a desired area of said mobile platform and for generating output signals representing a video image of said desired area;
a radio frequency communications subsystem carried onboard said mobile platform for communicating said output signals to said remotely located monitoring system; and
a recorder subsystem located on board the mobile platform for recording said output signals for viewing later in time.

2. The surveillance system of claim 1, wherein a plurality of video cameras are included for monitoring a plurality of areas within said mobile platform.

3. The surveillance system of claim 2, further comprising a distribution subsystem for transmitting said output signals from said video camera to said radio frequency communications subsystem.

4. The surveillance system of claim 1, wherein said radio frequency communications subsystem operates to receive camera control commands from said remotely located monitoring station; and
wherein said system further comprises a video control unit for receiving said camera control commands and using said camera control commands to control operation of said video camera.

5. The surveillance system of claim 1, wherein said system comprises a video control unit which acts as an interface between a plurality of said cameras.

6. The surveillance system of claim 1, wherein said system comprises a video control unit which provides said video cameras with electrical current and electrical current surge protection.

7. The surveillance system of claim 1, wherein said system comprises a computer server capable of storing said signals from said video camera using a suitable electronic storage device.

8. The surveillance system of claim 1, wherein said video camera comprises a color camera capable of producing an image which meets or exceeds the standards set by the National Television Standards Committee.

9. The surveillance system of claim 1, wherein said control commands transmitted to said video camera instruct said camera to perform at least one of the functions: pan, rotate, and zoom.

10. The surveillance system of claim 1, wherein said video images are stored in a recorder subsystem responsive to said output signals.

11. A method for transmitting a radio frequency signal representing video images of a predetermined area of a mobile platform, the method comprising:
using at least one video camera positioned to view said predetermined area;
using a radio frequency communications system responsive to output signals from said video camera to generate radio frequency signals representing video images viewed by said video camera; and
using a base station for receiving said radio frequency signals from said radio frequency subsystem and for transmitting radio frequency signals representing control commands to said video camera to control operation of said video camera.
